(19) United States
(12) Patent Application Publication
(10) Pub. No.: US 2011/0129289 A1
(43) Pub. Date: Jun. 2, 2011

(54) Refill Adaptor

(76) Inventor: Lalit Agrawal, West Bengal (IN)

(21) Appl. No.: 12/520,106

(22) PCT Filed: Sep. 8, 2008
(86) PCT No.: PCT/IN2008/000573

§ 371 Date: Jun. 19, 2009

(30) Foreign Application Priority Data
Apr. 2, 2008 (IN) 663/KOL/2008

(51) Int. Cl. B43K 7/02

(52) U.S. Cl. 401/208

(57) ABSTRACT

A refill adaptor for using in a BIC style ball point pen essentially comprising a main body (10), a front cone (15), a rear shank having an inner shank portion (18) and an outer shank portion (20). The said inner shank portion (18) and said outer shank portion (20) are fitted to said front cone (15) with a ring member (25) so as to form a continuous body to be fitted to the front portion of the ball point pen and for housing a refill tip and tube along its longitudinal axis to form a ball point pen refill.

### FIELD OF THE INVENTION

The invention relates to an adaptor to be used for making a refill for use in ball point pens. The invention particularly relates to a refill adaptor to be used in making a refill in relation to ball point pen using mini tips.

### PRIOR ART

The currently available pen refills in the market fall into two broad categories.: i) Refills using adaptor, BIC (BIC is a trade mark of BIC Corporation, France) style type ball point tips, refill tube and ink. The shank diameter of the adaptor is usually about 4 mm.

ii) Refills using ball point pen tips like pilot, D6, D4, Ohto, Zebra, etc, refill tube and ink. In this refill, there is no possibility to use mini tips.

In conventional ball point pens, the tips are made from wires of brass or nickel silver alloy having an average diameter between about 2 and about 2.30 mm.

The conventional type of ball point pens suffer from disadvantages. One of the drawbacks is that it requires extra material in making the tip with bigger diameter wire than what is actually required in the mini tips having lesser wire diameter of 1.6 mm. Further, there is no adaptor available in the market which could accommodate tips made from lesser diameter wire. Thus the cost of the existing ball pen refills can be reduced by making them adaptable for use with mini tips by using newly designed adaptor.

In the conventional ball point pens using BIC style refills, refills are made using adaptor, BIC style ball point tips, refill tube and ink. There are two types of refills available in the market and widely used wherein the tips are made from wire of brass or nickel silver alloy having a diameter ranging between about 2 and about 2.30 mm. It has been found that the diameter between about 2.00 and about 2.30 mm was necessary to make the refill to have adequate ink in the ball point pen. The main disadvantage associated with known ball point pen is that at present all known adaptors for refills uses ball pen tips made from about 2.00-2.30 mm brass/NS wire. Further, there is no adaptor whereby about 1.50-1.65 mm diameter wire tips can be used in any refill. It has therefore been the endeavor of the applicant to mitigate these drawbacks of the conventional ball point pens and to make a ball point pen using an adaptor for refill of no less strength but of less material and thereby reducing the cost considerably.

### OBJECTS OF THE INVENTION

Thus one of the objects of the invention is to provide a ball point pen having an adaptor for refill for using particularly in BIC style ball point pens using mini tips made from about 1.50-1.65 mm diameter wire of brass or nickel silver alloy.

It is another object of the invention to provide a ball point pen having an adapter, which has reduced cost of the refill without any alteration in the ball point pens or the ink quantity necessary for adequate writing.

### DESCRIPTION OF THE INVENTION

According to the present invention a refill adaptor suitable for ball point pen essentially comprising a main body having a front cone portion, a rear shank having an inner shank portion and an outer shank portion; said inner shank and said outer shank being moulded together to said front cone with a ring member so as to form a continuous body to be fitted to the front portion of the ball point pen and for housing a refill tube along its longitudinal axis.

Typically, the outer diameter of the outer shank is about 3.95-4.05 mm and the inner diameter is about 2.8 mm.

A refill adaptor of the present invention has an outer diameter of the inner shank of about 1.7 mm and the inner hole diameter of about 0.8 mm for free flow of ink.

A refill adaptor wherein the tip of the refill is housed within the housing moulded together with the front cone so as to hold the refill tip along the longitudinal axis of the refill.

A refill adaptor wherein the rear end of said inner shank rigidly moulded together to the front portion of the housing which holds the refill tube with ink filled into it.

The present invention therefore provides a new ball point pen refill with an adaptor which is much more economical. Further, such adaptor also saves the cost of the material of the tip.

With the newly designed adaptors, one can now use about 1.50-1.65 mm diameter wire ball pen tips in the BIC type refills which are not possible without the present invention.

The advantages of the new adaptor include ability to use about 1.50-1.65 mm diameter wire ball pen tips in the BIC type refills, thereby cutting cost as compared to about 2.00-2.30 mm diameter ball pen tips.

### BRIEF DESCRIPTION OF THE DRAWINGS

The improved refill adaptor of the present invention is described herein below with reference to the accompanying drawings, wherein

FIG. 1 shows a side plan of the refill adaptor of the present invention;

FIG. 2 shows a section of the refill adaptor of the present invention; and

FIG. 3 shows the refill adaptor of the present invention fitted with a refill tip and refill tube.

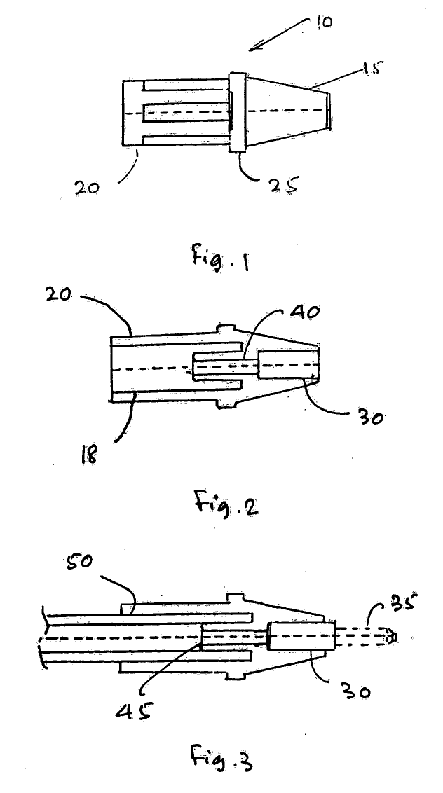

With reference to the accompanying drawings, the refill adaptor essentially comprises a main body (10) as illustrated having a front cone (15) and a rear shank (20). The said rear shank (20) is integrally rigidly connected to the front cone (15) through a ring (25) so as to form a housing for the ball point refill tube. The front cone, the rear shank and the ring member may preferably be moulded together so as to form one integrated piece.

FIG. 2 shows a cross section of the refill adaptor having an inner shank (18), an outer shank (20), a housing (30) for the ball pen tip of the refill and a channel (40) for said refill adaptor. Said housing (30) and said channel (40) are connected together in a manner as illustrated in FIG. 2 and are housed within said adaptor to accommodate the refill tube as illustrated in FIG. 3 for free flow of ink.

FIG. 3 shows a housing (30) through which the ball pen tip (35) is inserted and remain in position with the help of the rear end (45) of the inner shank while the refill tube (50) remains slideably housed within the main ball point pen body without touching the housing of the tip (30).

FIGS. 2 and 3 illustrate an ink channel (40) which extends from the tip (35) and is fitted between the housing of the tip and the rear end (45) of the inner shank.

It will be apparent from the drawings that the adaptor is used in relation to BIC type ball pens having the refill fitting hole-diameter of about 3.95-4.05 mm for the fitment of the adaptor.

It is known among persons skilled in the art that the main difference between the ordinary and BIC type tipped refill are as follows
a) The tip used is BIC type while the ordinary refill uses pilot, D6, D4, Ohto, Zebra or such other type of tips without adaptor.
b) There is no adaptor in ordinary type of refills enabling it to use 1.6 mm wire mini tip.
c) The BIC type refills are front loading while the ordinary refills are rear loading

The invention has been described with reference to various specific and preferred embodiments and techniques which are provided merely to be exemplary of the invention and do not limit the scope of the invention. It should be understood that many variations and modifications will be apparent to those skilled in the art while remaining within the spirit and scope of the invention and all such modifications and equivalents are intended to be included within the scope of the present invention.

1. A refill adaptor for use in a BIC style ball point pen comprising a main body (10), a front cone (15), a rear shank having an inner shank portion (18) and an outer shank portion (20); said inner shank portion (18) and said outer shank portion (20) being fitted to said front cone (15) with a ring member (25) so as to form a continuous body to be fitted to the front portion of the ball point pen and for housing a refill tip and tube along its longitudinal axis to form a ball point pen refill.

2. The refill adaptor as claimed in claim 1, wherein outer diameter of said outer shank (20) is between about 3.95 and 4.05 mm and an inner diameter is about 2.8 mm.

3. The refill adaptor as claimed in claim 1, wherein outer diameter of said inner shank is about 1.7 mm and the inner diameter of the inner shank is about 0.8 mm.

4. The refill adaptor as claimed in claim 1, wherein tip of the refill (35) is housed within the housing (30) fitted to the front cone (15) so as to hold the refill tube (50) along the longitudinal axis of the adaptor.

5. The refill adaptor as claimed in claim 4, wherein said refill tube is so shaped to be accommodated in the rear portion of the housing of said tip portion.

6. The refill adaptor as claimed in claim 1 wherein the rear end (45) of said inner shank rigidly sits on the front portion of the housing within said refill tube (50).

7. The refill adaptor as claimed in claim 2, wherein tip of the refill (35) is housed within the housing (30) fitted to the front cone (15) so as to hold the refill tube (50) along the longitudinal axis of the adaptor.

8. The refill adaptor as claimed in claims 3, wherein tip of the refill (35) is housed within the housing (30) fitted to the front cone (15) so as to hold the refill tube (50) along the longitudinal axis of the adaptor.

9. The refill adaptor as claimed in claim 2 wherein the rear end (45) of said inner shank rigidly sits on the front portion of the housing within said refill tube (50).
